(19) United States
(12) Patent Application Publication
(10) Pub. No.: US 2010/0187057 A1
(43) Pub. Date: Jul. 29, 2010

(54) HYDRODYNAMIC RETARDER WITH A TANGENTIAL INFLOW AND OUTFLOW PRINCIPLE

(75) Inventors: Thomas Meid, Deggenhausertal (DE); Michael Huber, Langenargen (DE); Andreas Ulmer, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/666,515

(22) PCT Filed: Jun. 19, 2008
(86) PCT No.: PCT/EP08/57750

§ 371 Date: Dec. 23, 2009

(30) Foreign Application Priority Data
Jul. 25, 2007 (DE) 10 2007 034 562.5

(51) Int. Cl. F16D 57/04; F16D 57/00

(52) U.S. Cl. 188/290

(57) ABSTRACT

A hydrodynamic retarder with a tangential inflow and outflow principle which is achieved by the rotor (1) and the stator (2) having a predetermined eccentricity relative to one another. A variable outlet gap (6) is formed about a circumference of the hydrodynamic retarder between the rotor (1) and the stator (2).

This application is a National Stage completion of PCT/EP2008/057750 filed Jun. 19, 2008, which claims priority from German patent application serial no. 10 2007 034 562.5 filed Jul. 25, 2007.

### FIELD OF THE INVENTION

The present invention relates to a hydrodynamic retarder operating with tangential inflow and outflow.

### BACKGROUND OF THE INVENTION

In hydrodynamic retarders, the flow energy of a liquid is used for braking, the physical action principle corresponding to that of a hydrodynamic clutch with a fixed turbine. According to this, a hydrodynamic retarder comprises a rotor positioned in the power flow and a stator connected in a fixed manner to the retarder housing. When the retarder is actuated, a quantity of oil corresponding to the braking power desired is introduced into the blade space so that the spinning rotor accelerates the oil and transfers it to the stator. This results in a braking effect on the rotor shaft.

From the prior art retarders are known, in which a displacement device is provided by means of which the stator blade wheel can be pivoted to an eccentric position relative to the rotor blade wheel.

For example, from DE 44 20 204 C2 a hydrodynamic retarder with a fixed housing that can be filled with working liquid is known, which comprises a rotating rotor blade wheel connected to a driveshaft and a stator blade wheel that can be pivoted to an eccentric position relative to the rotor blade wheel and which is mounted eccentrically and can pivot on a longitudinal axis arranged parallel to the rotor blade wheel axis when in the assembled position. In this case, in the assembled position the bearing axis is arranged in an area bounded by the outer diameter of the rotor blade wheel; the stator blade wheel is free from additional displacement means for bringing about the pivoting movement, so that, respectively, during the emptying process it pivots automatically due to the force of gravity, while during the filling process it moves in opposition to the force of gravity because of a pair of forces produced by an impulse exchange between the rotor and stator blade wheels. During braking operation the rotor and the stator assume a substantially coaxial position relative to one another.

Moreover, in this known retarder at least one abutment is provided, which restricts the pivoting motion of the stator blade wheel during the filling process at the latest when a maximum overlap between the rotor and stator wheel admission has been reached, such that in the emptied condition the stator blade wheel is positioned relative to the rotor blade wheel in such manner that at least part of the blading of the stator blade wheel overlaps the admission of the rotor blade wheel.

From DE 4010970 C2 a hydrodynamic retarder with a fixed housing that can be filled with working liquid is known, which comprises a rotating rotor blade wheel connected to a driveshaft and a non-rotating stator blade wheel that can be displaced to an eccentric position relative to the rotor blade wheel, and a displacement device for moving the stator blade wheel. In this case the displacement device can be acted upon by a pressure medium on one side, whereby the stator blade wheel can be pivoted to the eccentric position.

In the case of hydrodynamic retarders that operate with tangential inflow and outflow, when the retarder is partially filled, i.e. filled with a small quantity of oil, the medium flowing in drains out directly through the tangential outlet without completing or re-closing the hydrodynamic circuit. To achieve a small change of the braking torque, in such an operating range a large change of the associated control pressure is needed.

If the filling of the retarder is increased, then from a certain filling level onward the hydrodynamic circuit is closed and when this is so, only small control pressure changes are needed to produce large braking torque changes.

Thus, in hydrodynamic retarders with tangential inflow and outflow there are two different operating ranges, and at the transition between the two ranges an instability occurs which leads to marked fluctuations of the braking torque, since at that operating point there is frequent alternation between a closed and an open hydrodynamic circuit.

### SUMMARY OF THE INVENTION

The purpose of the present invention is to propose a hydrodynamic retarder with tangential inflow and outflow, in which the instability between the two operating ranges is largely avoided.

According to these, a hydrodynamic retarder with tangential inflow and outflow is proposed, in which a closed hydrodynamic circuit is produced even with only partial filling in some areas.

In this way the tangential outflow in these areas is restricted, but without conflicting with the functional principle of tangential outflow. In turn, this results in avoidance of the unstable operating range.

According to the invention this is achieved in that the rotor has a predetermined, non-variable eccentricity relative to the stator, so that the radial gap between the rotor and stator components is variable around the circumference by virtue of the eccentricity according to the invention, whereby a closed circuit is produced in some areas of the retarder since in that case the oil cannot flow out.

### BRIEF DESCRIPTION OF THE DRAWINGS

Below, an example of the invention is explained in greater detail with reference to the attached figures, which show:

FIG. 1: Schematic representation of a first embodiment of the invention;

FIG. 2: Schematic representation of a second embodiment of the invention;

FIG. 3: Schematic representation of a third embodiment of the invention; and

FIG. 4: Sectional view of a hydrodynamic retarder designed according to the invention.

### DETAILED DESCRIPTION OF THE PREFERRED EMBODIMENTS

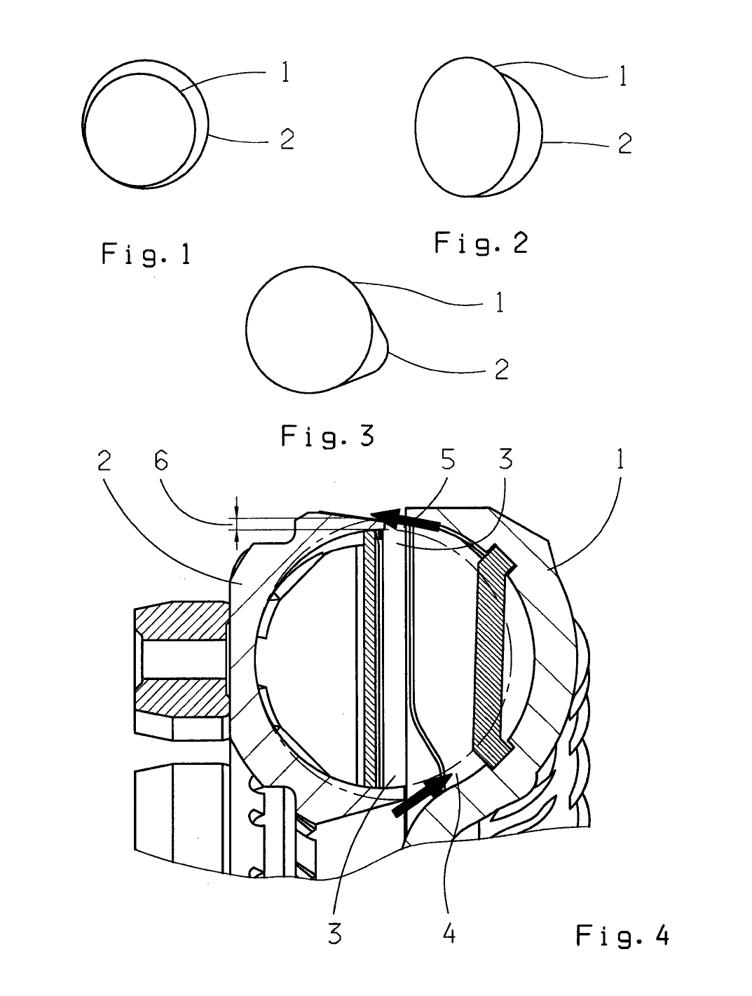

FIG. 1 shows a possible embodiment of a hydrodynamic retarder according to the invention. In this, the rotor 1 and stator 2 are mounted eccentrically relative to one another. By virtue of this design the outlet gap between the rotor 1 and the stator 2 can be larger or smaller, so that even with extreme partial filling a closed circuit can be formed in some areas and the flow of oil bypasses the outlet, thereby preventing tangential outflow of the oil.

In the embodiments shown in FIGS. 2 and 3 this is achieved in that alternatively or in addition to their eccentric mounting, the rotor 1 and/or the stator 2 have a geometry that non-circular. For example, the rotor 1 and/or the stator 2 can be elliptical.

In FIG. 4, the air gap between the rotor 1 and the stator 2 is indexed 3. In the hydrodynamic retarder with tangential inflow and outflow shown, the oil flows, in the direction of the arrow, through the inlet 4 into the retarder and, in the direction of the other arrow, out through the outlet 5. As can be seen from FIG. 4 the radial outlet gap 6 between the rotor 1 and the stator 2 components is variable by virtue of the eccentricity according to the invention, so that in some areas of the retarder a closed circuit is maintained since the oil cannot flow out there.

### Indexes

1 Rotor
2 Stator
3 Running gap
4 Inlet
5 Outlet
6 Outlet gap

1-4. (canceled)

5. A hydrodynamic retarder with tangential inflow and outflow, wherein a rotor (1) has a non-adjustable, predetermined eccentricity relative to a stator (2).

6. The hydrodynamic retarder with tangential inflow and outflow according to claim 5, wherein the rotor (1) and stator (2) are both mounted eccentrically relative to one another.

7. The hydrodynamic retarder with tangential inflow and outflow according to claim 6, wherein in addition to their eccentric positioning, at least one of the rotor (1) and the stator (2) has a geometry that deviates from circularity.

8. The hydrodynamic retarder with tangential inflow and outflow according to claim 7, wherein at least one of the rotor (1) and the stator (2) have an elliptical shape.

9. The hydrodynamic retarder with tangential inflow and outflow according to claim 5, wherein at least one of the rotor (1) and the stator (2) have a geometry that deviates from circularity.

10. A hydrodynamic retarder with tangential inflow and outflow, the retarder comprising a rotor (1) and a stator (2),
wherein the rotor (1) is eccentric with respect to the stator (2) such that an outlet gap (6) is formed about a circumference of the hydrodynamic retarder, between the rotor (1) and the stator (2), which has a variable size.

11. A hydrodynamic retarder with tangential inflow and outflow, the retarder comprising a rotor (1) and a stator (2),
wherein one of the rotor (1) and the stator (2) has a circular circumference and the other of the rotor (1) and the stator (2) has an elliptical circumference such that an outlet gap (6) is formed about a circumference of the hydrodynamic retarder, between the rotor (1) and the stator (2), which has a variable size.

12. The hydrodynamic retarder according to claim 11, wherein the rotor (1) has a circular circumference and the stator (2) has an elliptical circumference.

13. The hydrodynamic retarder according to claim 11, wherein the stator (2) has a circular circumference and the rotor (1) has an elliptical circumference.
